(19) United States
(12) Patent Application Publication
(10) Pub. No.: US 2012/0166120 A1
(43) Pub. Date: Jun. 28, 2012

(54) Method Capable Of Discriminating Between A Gamma Component And A Neutron Component In An Electronic Signal

(76) Inventors: Gwenole Corre, Saint Aubin (FR); Vladimir Kondrasovs, Palaiseau (FR); Stéphane Normand, Mantes La Jolie (FR)

(21) Appl. No.: 13/380,809

(22) PCT Filed: Jun. 22, 2010
(86) PCT No.: PCT/EP10/58830

§ 371 Date: Mar. 6, 2012

(30) Foreign Application Priority Data
Jun. 24, 2009 (FR) 09 54306

(51) Int. Cl. G06F 19/00

(52) U.S. Cl. 702/71

(57) ABSTRACT

The invention concerns a method capable of discriminating between a gamma component and neutron component in an electronic signal (S1) resulting from the detection of gamma and/or neutron radiation, characterized in that it comprises the following steps:
delaying by a time TAU and attenuating by a coefficient ALPHA the signal (S1), to obtain a delayed and attenuated signal (S2),
subtracting the delayed and attenuated signal (S2) from the electronic signal (S1) to obtain a difference signal (S3) which comprises a gamma component and/or neutron component, and
computing a magnitude sigma1 such that:

$$sigma 1 = {\int }_{δ}^{T 2} {S}_{3} ( t ) d t$$

where δ is an instant when the gamma component passes zero and T2 is a previously determined instant later than instant δ chosen so that, in an interval [δ_{ref}, T2], the magnitude sigma1 is negative for a gamma component and positive for a neutron component.

The invention concerns a method capable of discriminating between a gamma component and a neutron component in an electronic signal resulting from the detection of gamma and/or neutron radiation.

### BACKGROUND OF THE INVENTION

In the nuclear field, there is a need to discriminate between the radiation parts derived from neutrons and the radiation parts derived from gamma rays in order to identify the NR threat (NR standing for “Nuclear and Radiological”), for example to evaluate the seriousness of a threat or, in more specific terms, to evaluate a mass of fissile matter.

At the current time, discrimination using signals derived from organic scintillators is carried out by pulse shape analysis. Two known processes are used which are based on a principle which makes use of a population difference in the energy states of molecules depending upon the ionizing power of incident particles, this being related to their mass and charge.

A first method entails the duplicating of a signal derived from the scintillator onto two lines. The signal of the first line is integrated then differentiated. The zero cross-over of the signal is characteristic of a particle which has interacted with the fluorescent material of the scintillator. The time distance between the start of the said signal and zero cross-over is then determined. On the second line, the start of the signal is determined by a constant fraction discriminator. The time thus determined is directly related to the particle which has interacted with the scintillator. The longer this time the more the particle is ionizing.

The second process entails integrating a signal derived from a scintillator into two different time windows, the first containing the entire signal and the second only the so-called delayed part i.e. the part contained in the second part of the signal, the decaying part. Using bi-parametric analysis, it is then possible to distinguish between two parts in the two-dimensional graph displaying total charge versus delayed charge, each corresponding to a region of interest containing the pulses of either neutron origin or gamma origin.

These two methods compare two signals with each other. One disadvantage related to comparison between two signals is that, having regard to the variability of shapes, it is very difficult to discriminate between the particles when signal differences are very small, which is the case with solid organic scintillators.

### SUBJECT OF THE INVENTION

The subject of the invention is a method for particle discrimination, adapted so that it can be used with solid organic scintillators and does not have the disadvantages of the prior art.

### BRIEF DESCRIPTION OF THE INVENTION

For this purpose, the invention proposes a method capable of discriminating between a gamma component and a neutron component in an electronic signal resulting from the detection of gamma and/or neutron detection, characterized in that it comprises the following steps performed by a computer:
delaying the electronic signal by a time TAU and attenuating it by a coefficient ALPHA to obtain a delayed and attenuated signal,
subtracting the delayed and attenuated signal from the electronic signal to obtain a difference signal which comprises a gamma difference component and/or a neutron difference component, and
computing a magnitude sigma1 such that:

$$sigma 1 = {\int }_{δ}^{T 2} {S}_{3} ( t ) d t$$

where δ is an instant when the gamma difference component passes zero and T2 is a previously determined instant later than instant δ chosen so that, within an interval [δ_{ref}, T2], the sigma1 magnitude is negative for a gamma component and positive for a neutron component.

### BRIEF DESCRIPTION OF THE FIGURES

Other characteristics and advantages of the invention will become apparent in the light of a preferred embodiment described with reference to the appended figures, among which:

FIG. 1 gives a block diagram of a detection system of the invention;

FIG. 2 gives a detailed diagram of a circuit which belongs to the system shown in FIG. 1;

FIGS. 3a-3d and 4a-4d illustrate different gamma and neutron signals, able to illustrate different steps of the discrimination method of the invention;

FIG. 5, as an example, shows the display of a result obtained using the discrimination method of the invention.

In all the figures, the same references designate the same parts.

### DETAILED DESCRIPTION OF THE PREFERRED EMBODIMENT OF THE INVENTION

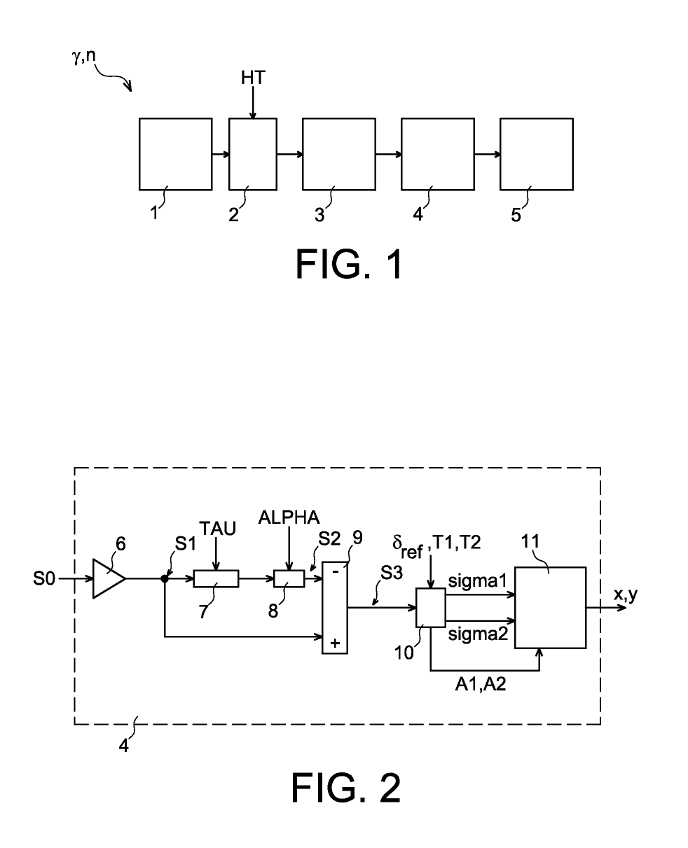

FIG. 1 gives a block diagram of a detection system according to the invention.

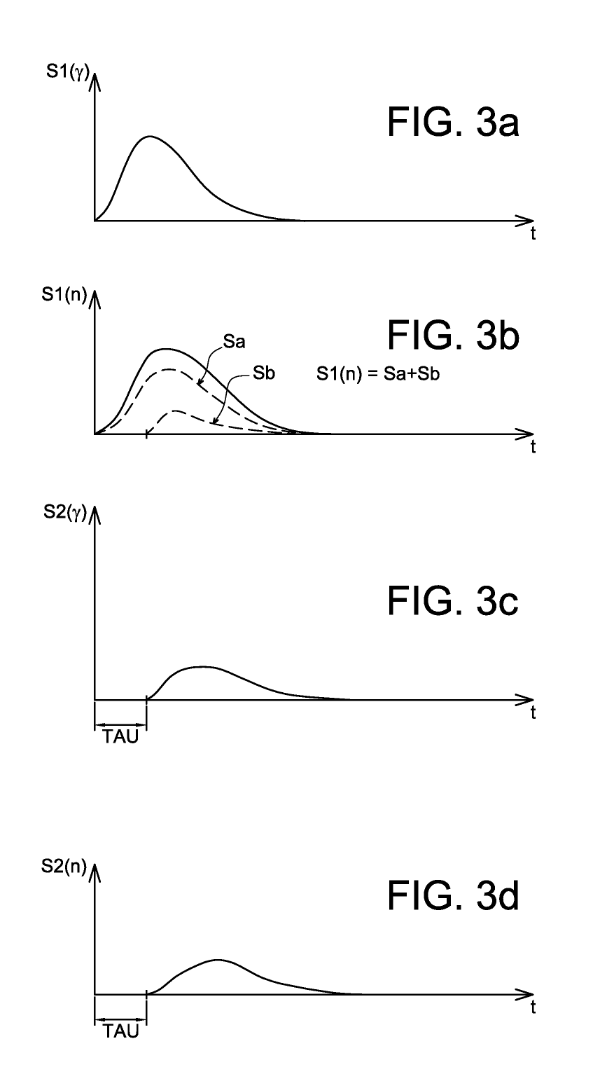

The system comprises a detector 1, for example a solid organic scintillator, adapted to receive gamma rays and/or neutron rays. The output of the detector 1 is connected to the input of a photomultiplier 2 polarised by a high voltage HT. The photomultiplier 2 has an output connected to the input of an analog/digital converter 3 (e.g. a 1 GHz converter, 8 bits), whose output is connected to the input of a computer 4. The computer 4 is described in detail with reference to FIG. 2. The output of the computer 4 is connected to a display device 5 which displays the result of calculations performed by the computer.

According to the embodiment shown in FIG. 1, the detection system comprises an analog/digital converter 3. However, it is to be noted that the invention also concerns cases in which the detection system does not comprise an analog/digital converter. The treatment of signals is therefore an analog treatment.

When in operation, gamma and/or neutron rays interact with the solid organic scintillator 1, which delivers a light signal that is transmitted to the photomultiplier 2. The photomultiplier 2 performs light/electron conversion and delivers an electronic signal which is transmitted to the analog/digital converter 3 which converts the analog signals to digital signals. The digital signals are then sent to the computer 4. The results of the computer 4 are then displayed on the display device 5.

FIG. 2 gives a detailed view of the computer 4. The input circuit of the computer 4 preferably comprises a pre-amplifier 6. This pre-amplifier may however be omitted if the detection system comprises a photomultiplier 2 whose performance is sufficient to induce a usable signal. The output of the pre-amplifier 6 is connected firstly to the input of a delaying device 7 and secondly to a first input of a difference operator 9. The output of the delaying device is connected to the input of an attenuating device 8 whose output is connected to a second input of the difference operator 9. The output of the difference operator 9 is connected to the input of an extraction operator 10 of which a first output is connected to a first input of an acquisition device 11 and a second output is connected to a second input of the acquisition device 11. The output of the acquisition device 11 is connected to the input of the display device 5.

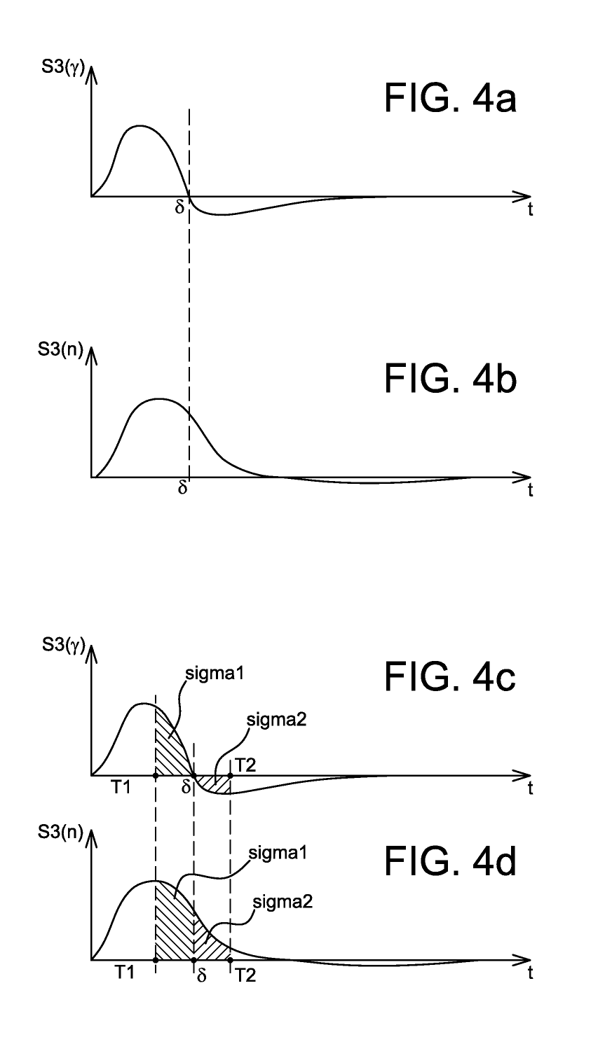

When in operation, a signal S0 is input into the pre-amplifier 6. The pre-amplifier 6 amplifies the signal S0 and delivers a signal S1. The signal S1 comprises a gamma component and/or a neutron component, the neutron component itself being broken down into two superimposed components, namely a rapid component due to prompt de-excitation in the material of the scintillator and a delayed component due to delayed de-excitation in the material of the scintillator. FIGS. 3a and 3b respectively show a gamma component S1(γ) and a neutron component S1(n) of the signal S1 in cases when signals are analogical. The neutron component S1(n) comprises the rapid neutron component Sa and the delayed neutron component Sb.

The signal S1 which is delivered by the pre-amplifier 6 is then directly transmitted to the first input of the difference operator 9 and, via the delaying device 7 and the attenuating device 8, onto the second input of the operator 9. The delaying device 7 delays the signal by a time TAU and the attenuating device 8 attenuates the signal by a coefficient ALPHA. A signal S2 is delivered by the delaying device 8. FIGS. 3c and 3d respectively show the delayed, attenuated gamma component S2(γ) and the delayed and attenuated neutron component S2(n) of the signal S2. The chosen TAU and ALPHA values derive from a previously performed iteration process which is described below. TAU preferably has a value within the interval ]0, 10 ns] and ALPHA preferably has a value within the interval ]0, 1].

The difference operator 9 then determines the difference between signal S1 and signal S2. The signal S3 delivered at the output of the operator 9 is then:

S3=S1−S2

The signal S3 comprises a gamma component S3(γ) and/or a neutron component S3(n).

FIGS. 4a and 4b respectively illustrate the gamma component S3(γ) and neutron component S3(n) as a function of time. The signals S3(γ) and S3(n) both pass zero, signal S3(γ) passing zero at an instant δ which precedes the instant when signal S3(n) passes zero. The extraction operator 10 which receives the signal S3 is programmed to be used after an instant T1 up until an instant T2 around an instant δ_{ref}. The extraction operator 10 comprises means capable of measuring the zero cross-over instant δ of signal S3(γ) during the interval [T1, T2]. The instants δ_{ref}, T1 and T2 are determined, as is detailed below, during the previously mentioned iteration process.

The extraction operator 10 computes the magnitudes of sigma1 and sigma2 such that:

$$sigma 1 = {\int }_{T 1}^{δ} {S}_{3} ( t ) d t$$

$$sigma 2 = {\int }_{δ}^{T 2} {S}_{3} ( t ) d t$$

FIGS. 4c and 4d symbolically illustrate the sigma1 and sigma2 quantities of each of the signals S3(γ) and S3(n).

The acquisition device 11 on its input receives the computed magnitudes of sigma1 and sigma2 and calculates the magnitudes x and y such that:

y=sigma1/A1, and

x=sigma2/A2

where A1 is the amplitude of the difference signal chosen at a given instant during time δ_{ref}−T1, for example instant T1, and A2 is the amplitude of the difference signal chosen at a given instant during time T2−δ_{ref}, for example instant T2. The magnitudes x and y are calculated for each pulse.

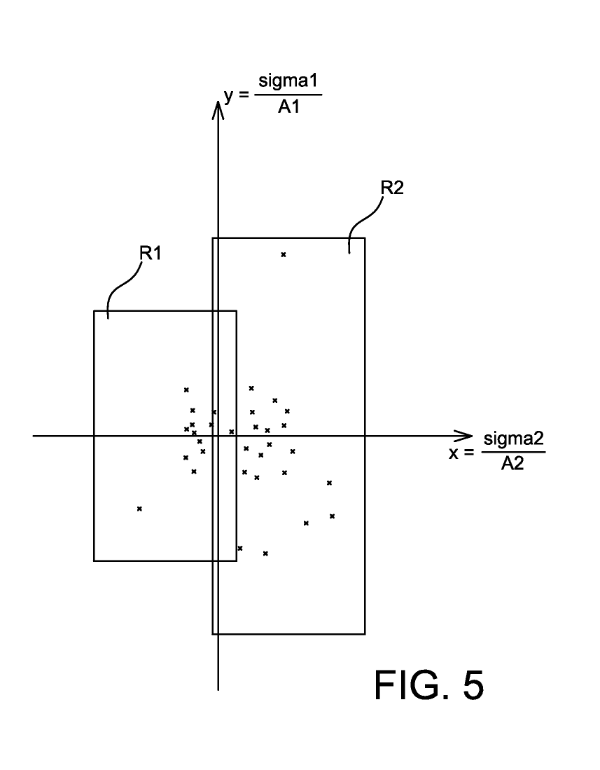

The result of processing performed by the acquisition device 11 is displayed by the display device 5. FIG. 5, as an example, illustrates the display of a result.

Advantageously, according to the invention, the fact that the received signal is correlated with itself makes it possible to take into account all the internal variability of the pulses forming the signal. It is then possible to calculate a magnitude (sigma2) capable of discriminating between a gamma signal and a neutron signal. The magnitude sigma2 is effectively negative for a gamma signal and positive for a neutron signal. By displaying in one same diagram the pair of values (x,y) for each incidence of a received ray, the values representing gamma radiation can then be separated from the values representing neutron radiation, the values representing gamma radiation being on the left side of the diagram and the values representing neutron radiation being on the right side. On this account, a region R1 chiefly located on the side of the negative x values groups together all incident gamma radiation, and a region R2 chiefly located on the side of the positive x values groups together all incident neutron radiation (see FIG. 5). The regions R1 and R2 may partly overlap however owing to the known phenomenon of diaphony.

Having regard to the type of rays being discriminated, the method of the invention can only lead to the obtaining of reliable results after integrating a large number of pulses. Although analysis is performed pulse per pulse, a pertinent result can only be considered from a global viewpoint, when a number of analyses have been performed. Typically, an analysis of between 100 and 1000 unit pulses (gamma and/or neutrons) is needed to obtain a pertinent result allowing analysis of the type of observed radiation source.

The iteration process conducted to determine the parameters TAU, ALPHA, δ_{ref}, T1 and T2 will now be described.

First, a first reference gamma signal is sent to the input of the detection system of the invention for which arbitrary values of TAU and ALPHA are chosen as respective initial adjustment parameters for the delaying device 7 and attenuating device 8. The chosen values of TAU and ALPHA are respectively 5 ns and 0.5 for example.

A signal S3(γ) is then taken from the output of the operator 9 and the values of TAU and ALPHA are modified until the curve of the signal S3(γ) as a function of time has a shape that is substantially identical to the shape illustrated FIG. 4c, i.e. until the signal S3(γ) passes zero at a time δ_{ref} and has a positive part and a negative part that are clearly separate either side of instant δ_{ref}.

On the basis of the curve S3(γ) thus optimized, the instants T2 and T1 are then chosen. Instant T2 is an instant that is later than instant δ_{ref}, chosen for example as being the instant located beyond 15% of the instant when the negative part of the signal S3(γ) reaches its maximum in absolute value (minimum negative value). Instant T1 is an instant prior to instant δ_{ref}, for example chosen to be the instant located beyond 15% of the instant when the positive part of the signal S3(γ) is at its maximum. Signals x_{refγ} and y_{refγ} corresponding to the values chosen for the parameters TAU, ALPHA, δ_{ref}, T1 and T2 are then delivered by the acquisition device 11.

Other reference gamma signals are then sent to the input of the detection system of the invention, for example ten series of one thousand successive signals. The parameters TAU, ALPHA, δ_{ref}, T1 and T2 are then optimized in order best to group together the pairs x_{refγ} and y_{refγ} which are delivered by the different reference signals.

Once the parameters TAU, ALPHA, δ_{ref}, T1 and T2 have thus been optimized, reference signals containing gamma rays and neutrons are in turn sent to the input of the detection system, for example ten series of one thousand successive signals. Further optimization of all the parameters TAU, ALPHA, δ_{ref}, T1 and T2 is then conducted so as, this time, to better separate the pairs x_{refγ} and y_{refγ} obtained from the gamma rays, from the pairs x_{refn}, and y_{refn} obtained from the neutrons.

When it is considered that the pairs x_{refγ} and y_{refγ} obtained from the gamma rays are globally well separated from the pairs X_{refn} and y_{refn} obtained from the neutrons, the values of TAU, ALPHA, δ_{ref}, T1 and T2 are chosen to be the values used for implementing the discrimination method of the invention.

1. A method capable of discriminating between a gamma component (S1(γ)) and a neutron component (S1(n)) in an electronic signal (S1) resulting from the detection of gamma and/or neutron radiation, characterized in that it comprises the following steps performed by a computer:
delaying by a time TAU and attenuating by a coefficient ALPHA the electronic signal (S1) to obtain a delayed and attenuated signal (S2),
subtracting the delayed and attenuated signal (S2) from the electronic signal (S1) to obtain a difference signal (S3) which comprises a gamma difference component (S3(γ)) and/or a neutron difference component (S3(n)), and
computing a magnitude sigma2 such that:
$$sigma 2 = {\int }_{δ}^{T 2} {S}_{3} ( t ) d t$$
where δ is an instant when the gamma difference component (S3(γ) passes zero and T2 is a previously determined instant that is later than instant δ chosen so that, within an interval [δ_{ref}, T2], the magnitude sigma2 is negative for a gamma component and positive for a neutron component.

2. The method according to claim 1, wherein the values of TAU, ALPHA, δ_{ref} and T2 are determined by iteration, using a succession of reference electronic signals, so that instant δ_{ref} represents an instant at which any gamma component of all the reference electronic signals substantially passes zero and so that instant T2 is such that the quantity sigma1 is negative for any gamma component of all the reference electronic signals and positive for any neutron component of all the reference electronic signals.

3. The method according to claim 1, wherein TAU has a value within the interval ]0, 10 ns] and ALPHA a value within the interval ]0, 1].

4. The method according to claim 1, wherein an additional magnitude sigma1 is calculated such that:
$$sigma 1 = {\int }_{T 1}^{δ} {S}_{3} ( t ) d t$$
instant T1 being a previously determined instant prior to instant δ chosen so that, in an interval [T1, δ_{ref}], the magnitude sigma1 is positive for a gamma component and for a neutron component.

5. The method according to claim 4, wherein the magnitudes sigma1 and sigma2 are transmitted to a display device.

6. A system capable of discriminating between a gamma component (S1(γ) and a neutron component (S1(n)) in an electronic signal resulting from the detection of gamma and/or neutron radiation, characterized in that it comprises:
a delaying device and an attenuating device respectively to delay, by a time TAU, and attenuate, by a coefficient ALPHA, the electronic signal (S1) in order to obtain a delayed and attenuated signal (S2),
a difference operator to subtract the delayed and attenuated signal (S2) from the electronic signal (S1) in order to obtain a difference signal (S3) which comprises a gamma difference component (S3(γ)) and/or a neutron difference component (S3(n)), and
a computing unit to calculate a magnitude sigma2 such that:
$$sigma 2 = {\int }_{δ}^{T 2} {S}_{3} ( t ) d t$$
where δ is an instant of zero cross-over by the gamma difference component (S3(γ)) and T2 is a previously determined instant that is later than instant 6 chosen so that, in an interval [δ_{ref}, T2], the magnitude sigma2 is negative for a gamma component and positive for a neutron component.

7. The system according to claim 6, which comprises means for computing an additional magnitude sigma1 such that:
$$sigma 1 = {\int }_{T 1}^{δ} {S}_{3} ( t ) d t$$
instant T1 being a previously determined instant prior to instant δ chosen so that, in an interval [T1, δ_{ref}], the magnitude sigma1 is positive for a gamma component and for a neutron component.

8. The system according to claim 7, which comprises a display device to which the magnitudes sigma1 and sigma2 are transmitted.
